(19) United States
(12) Patent Application Publication
(10) Pub. No.: US 2024/0324824 A1
(43) Pub. Date: Oct. 3, 2024

(54) UTENSILS AND METHODS OF USING THE SAME

(71) Applicant: Karen Yolanda Snider, Denver, CO (US)

(72) Inventor: Karen Yolanda Snider, Denver, CO (US)

(21) Appl. No.: 18/193,320

(22) Filed: Mar. 30, 2023

(51) Int. Cl. A47J 45/10

(52) U.S. Cl. CPC A47J 45/10; A47J 2201/00

(57) ABSTRACT

An example utensil includes a connector and a handle extending from the connector. The connector includes a first end and a second end spaced from the handle. The utensil also includes a first prong and a second prong attached to the first end and the second end, respectively. The first prong and the second prong are configured to move relative to the connector. For example, the first and second prongs may exhibit a first configuration when the first and second prongs exhibit a first maximum distance therebetween and a second configuration when the first and second prongs exhibit a second maximum distance therebetween, wherein the first maximum distance is different (e.g., less) than the second maximum distance. Moving at least one of the first prong or the second prong relative to the connector switches the first and second prongs between the first and second configurations.

### BACKGROUND

Utensils may be small hand held tools that are used for food preparation and other tasks. Common utensils may include utensils configured to cut food items to size, help cook food on an open fire or on a stove, bake food, grind items, etc. Generally, different utensils are made for each task.

### SUMMARY

Embodiments are directed to utensils and methods of using the same. In an embodiment, a utensil is disclosed. The utensil includes a handle, a connector including a first end and a second end, a first prong extending from the first end of the connector, and a second prong extending from the second end of the connector. The first prong and the second prong exhibit a first configuration and a second configuration. The first prong and the second prong exhibit a first maximum distance therebetween when the first prong and the second prong are in the first configuration and a second maximum distance therebetween when the first prong and the second prong are in the second configuration. The first maximum distance is different than the second maximum distance.

In an embodiment, a method of using a utensil is disclosed. The utensil includes a handle, a connector including a first end and a second end, a first prong extending from the first end of the connector, and a second prong extending from the second end of the connector. The method includes switching a first prong and a second prong from a first configuration to a second configuration. The first prong and the second prong exhibit a first maximum distance therebetween when the first prong and the second prong are in the first configuration and a second maximum distance therebetween when the first prong and the second prong are in the second configuration. The first maximum distance is different than the second maximum distance.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1A is an isometric view of a utensil, according to an embodiment.

FIG. 1B is a cross-sectional view of the utensil taken along plane 1B-1B.

FIG. 1C is a cross-sectional view of a portion of the utensil taken along plane 1C-1C.

FIGS. 1D and 1E are enlarged isometric views of a portion of the utensil illustrating the utensil in the first and second configurations, respectively, according to an embodiment.

FIG. 2A is an isometric view of a portion of a utensil, according to an embodiment.

FIG. 2B is a cross-sectional view of the utensil taken along plane 2B-2B.

FIG. 3A is an isometric view of a portion of a utensil, according to an embodiment.

FIG. 3B is a cross-sectional view of the utensil taken along plane 3B-3B.

FIGS. 4 and 5 are cross-sectional view of utensils exhibiting different shapes, according to different embodiments.

### DETAILED DESCRIPTION

Embodiments are directed to utensils and methods of using the same. An example utensil includes a connector and a handle extending from the connector. The connector includes a first end and a second end spaced from the handle. The utensil also includes a first prong and a second prong attached to the first end and the second end, respectively. The first prong and the second prong are configured to move relative to the connector thereby allowing the maximum distance between the first prong and the second prong to selectively change. For example, the first and second prongs may exhibit a first configuration when the first prong and the second prong exhibit a first maximum distance therebetween and a second configuration when the first prong and the second prong exhibit a second maximum distance therebetween, wherein the first maximum distance is different (e.g., less) than the second maximum distance. Moving at least one of the first prong or the second prong relative to the connector switches the first and second prongs from the first configuration to the second configuration or vice versa.

During use, the utensils disclosed herein may be used to lift, move, or otherwise manipulate a variety of objects. The objects manipulated by the utensils may include objects that are conventionally disposed over a heat source (e.g., grill, fire, smoker, stove, etc.). Examples of such objects include grates (e.g., grill grates), baskets (e.g., grilling baskets, vegetable baskets, smoking boxes/tubes, etc.), baking racks, pans, pots, trays, or any other type of object. The utensils may be switched between the first and second configuration to facilitate manipulating the objects. For example, the utensils may exhibit the first configuration when manipulating a first object. In other words, the maximum distance between the first and second prongs may exhibit a first maximum distance when manipulating the first object. The utensils may then be switched from the first configuration to the second configuration when the utensils are used to manipulate a second object. In other words, the maximum distance between the first and second prongs may be changed (e.g., increased) to the second maximum distance when switching the utensils from the first configuration to the second configuration. As will be discussed in more detail below, the first and second configurations may be selected based on the particular object to be manipulated by the utensils. For example, when the first object is a grate, the first maximum distance may correspond to the distance between some of the rods of the grate so that the first and second prongs may be positioned between the rods. Positioning the first and second prongs between the rods may be beneficial when lifting an object off the grate. Further, when the second object is a basket, the second maximum distance may correspond to the distance between some of the holes of the basket so that the first and second prongs may be partially inserted through the holes which may facilitate lifting of the basket.

The utensils disclosed herein exhibit several improvements over conventional utensils configured to move objects. In an example, conventional utensils include a hot pad or thermally insulated gloves. The hot pads or thermally insulated gloves operate by grabbing the object disposed over the heat source. However, the hot pads or thermally insulated gloves may be unusable when the object at disposed in the flame or the heat source is too large to protect the arms of the user. Also, prolonged contact between the hot pads or thermally insulated gloves may cause the object to burn the user through the hot pads or gloves. In an example, conventional utensils include a clamp configured to clamp against the object thereby allowing the clamp to remove the object from the heat source. However, the clamps needs large forces to grip the object to prevent the object from being dropped. In another example, convention utensils includes forks or fork-like devices. The fork or fork-like devices may only engage with objects because the fork or fork-like device may only engage objects having, for instance, set spacing between the rods of a grate or holes of a basket. However, the spacing between the rods of grates and holes of baskets often vary making the fork or fork-like devices impractical for lifting various object. Further, even if the fork or fork-like device can engage of the object, the shape of the prongs of the fork or fork-like device may allow the object to easily slide off the fork or fork-like device.

The utensils discloses herein are an improvement over such conventional utensils. For example, the handle of the utensils disclosed herein allow the utensils to remove objects from a large heat source or to hold the object for prolong periods of time without burning the user, unlike hot pads or thermally insulated gloves. The utensils disclosed herein are also configured to allow the object to rest thereon and, thus, do not require large clamping forces to prevent the object from being dropped. The ability to change the maximum width between the prongs of the utensils disclosed herein also allows the utensils to engage with almost any object, for instance, regardless of the spacing between rods of a grate or holes in a basket. The utensils disclosed herein may exhibit other improvements over conventional utensils as discussed in more detail below.

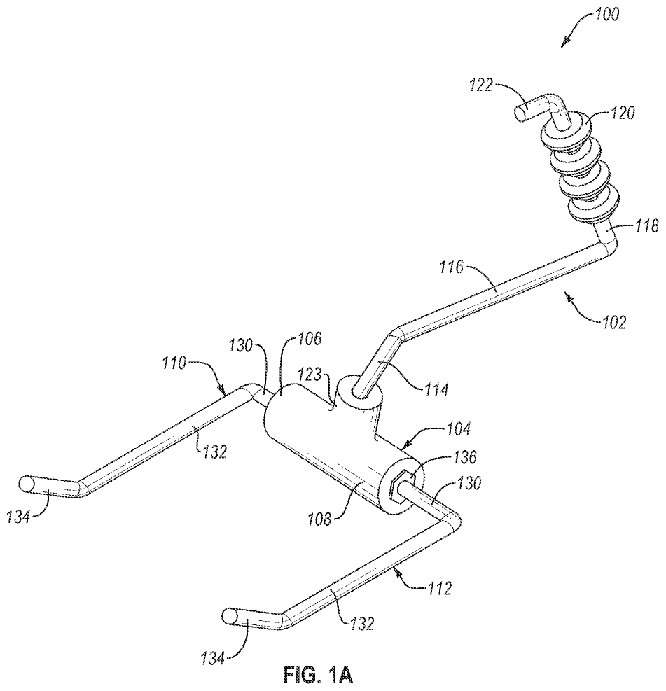

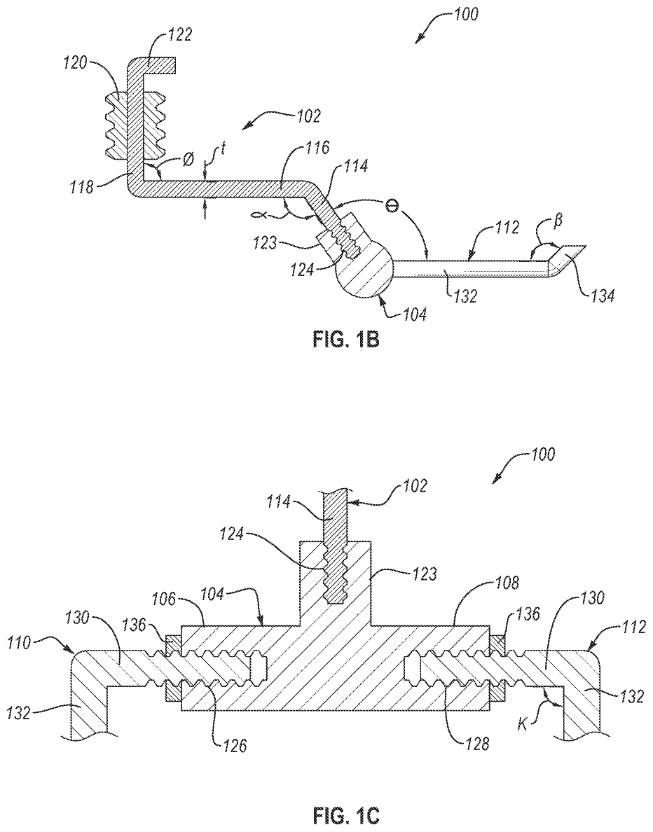

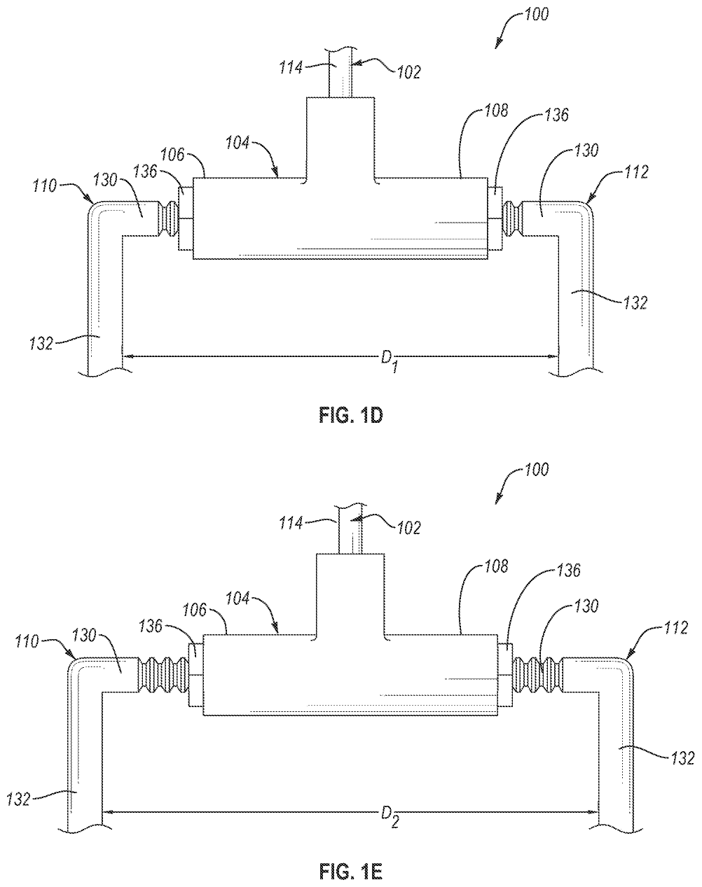

FIG. 1A is an isometric view of a utensil 100, according to an embodiment. FIG. 1B is a cross-sectional view of the utensil 100 taken along plane 1B-1B. FIG. 1C is a cross-sectional view of a portion of the utensil 100 taken along plane 1C-1C. The utensil includes a handle 102. The utensil 100 also includes a connector 104. The connector includes a first end 106 and a second end 108 spaced from the handle 102. The utensil 100 includes a first prong 110 and a second prong 112 attached to the first end 106 and the second end 108 of the connector 104, respectively. The first and second prongs 110, 112 are configured to selectively and controllably change a maximum distance therebetween thereby switching the utensil 100 between the first configuration and the second configuration, as discussed in more detail with regards to FIGS. 1D and 1E.

The handle 102 provides a location for a user to grip the utensil 100. The handle 102 extends from the connector 104 thereby allowing the user to grip the utensil 100 at a location that is spaced from the first and second prongs 110, 112. As such, the handle 102 provides a location for the user to grip when the first prong 110 and the second prong 1112 are position proximate to a heat source. In other words, the handle 102 allows the user to remain spaced from the heat source and provides a cooler location for the user to grip other than the first and second prongs 110, 112 which may be relatively hot.

The handle 102 may be formed from any suitable material. In an example, the handle 102 may be formed from steel (e.g., carbon steel, stainless steel, food grade steel, and hardened steel), aluminum, copper, titanium, a ceramic (e.g., silicon carbide), a polymer, a composite (e.g., carbon fiber), any other suitable material, or combinations thereof. In an example, the handle 102 may be formed from two or more materials. For instance, the portions of the handle 102 adjacent to the connector 104 may be formed from a material exhibiting a high operating temperature (e.g., a metal) since such portions of the handle 102 are likely to be disposed in or at least near the heat source. Meanwhile, the portions of the handle 102 spaced from the connector 104 may be formed from a lightweight material (e.g., carbon fiber, rigid polymer, etc.) since such portions of the connector 104 are unlike to be exposed to high temperatures. Forming a portion of the handle 102 from a lightweight material decreases the overall weight of the utensil 100 thereby making it easier to handle the utensil 100.

The handle 102 may exhibit a thickness t (e.g., diameter) of about 0.25 cm or greater, about 0.5 cm or greater, about 0.75 cm or greater, about 1 cm or greater, about 1.25 cm or greater, about 1.5 cm or greater, or in ranges of about 0.25 cm to about 0.75 cm, about 0.5 cm to about 1 cm, about 0.75 cm to about 1.25 cm, or about 1 cm to about 1.5 cm. The thickness t may be selected based on a number of factors. In an example, the thickness t is selected to be as small as possible to decrease the overall weight of the utensil 100 which makes it easier to use the utensil 100. In an example, the thickness t is selected to be large enough that the handle 102 is unlikely to bend or otherwise deform or fail when lifting an object at or below a pre-selected weight (e.g., an object exhibiting a weight of about 1 kg to about 10 kg, about 5 kg to about 15 kg, about 10 kg to about 20 kg, or about 15 kg to about 25 kg). In an example, the thickness t of the handle 102 may be selected depending on the type of beam that forms the handle 102. The type of beams that may form the handle 102 include a solid material (e.g., a rod), a hollow beam (e.g., a hollow beam exhibiting a circular or square cross-sectional shape), an I-beam, an n-shaped beam, a v-shaped beam, or another other suitable type of beam. In embodiment, the thickness t of the handle 102 remains constant or substantially constant along an entire length thereof. In an example, the thickness t of the handle 102 varies along at least a portion of the length thereof. For example, portions of the handle 102 expected to exhibit the largest bending stresses may exhibit a thickness that is greater than another portion of the handle 102.

In an embodiment, the handle 102 may be formed of a plurality of distinct pieces that are connected (e.g., welded) together. In an embodiment, the handle 102 may exhibit a unitary (i.e., single-piece) construction. It is noted that the handle 102 may be less likely to fail when the handle 102 exhibits a unitary construction than if the handle 102 is formed from a plurality of pieces. Whether the handle 102 exhibits unitary construction or is formed from a plurality of pieces may depend on, for example, whether the handle 102 is formed from a single or a plurality of materials, how the handle 102 is formed (e.g., cast or molded), or whether the handle 102 is formed from a solid material or a hollow material.

In an embodiment, as illustrated, the handle 102 includes a first section 114 extending directly from the connector 104, a second section 116 extending from the first section 114, and a gripping section 118 extending from the first section 114. The gripping section 118 is configured to be the portion of the handle 102 that is primarily gripped by the user though, it is noted, other portions of the handle 102 may also be gripped by the user. The first section 114 and the second section 116 are configured to space the gripping section 118 from the first and second prongs 110, 112 such that the gripping section 118 remains spaced from the heat source. For example, the first section 114 may be configured to at least vertically space the gripping section 118 from the first and second prongs 110, 112. Vertically spacing the gripping section 118 from the first and second prongs 110, 112 may space the gripping section 118 from the first and second prongs 110, 112. The second section 116 may extend at least laterally (e.g., horizontally) away from the first and second prongs 110, 112. The second section 116 may allow the gripping section 118 to not be vertically above the heat source since the thermal energy dissipated from the heat source generally rises.

The first section 114 exhibits a first length measured parallel to a longitudinal (e.g., central) axis of the first section 114. The first length may be measured along the portion of the first section 114 extending from the connector 104 and, optionally, the portion of the first section 114 disposed in the connector 104. The first length may be selected to be about 1 cm or greater, about 2 cm or greater, about 3 cm or greater, about 4 cm or greater, about 5 cm or greater, about 6 cm or greater, about 7 cm or greater, about 8 cm or greater, about 9 cm or greater, about 10 cm or greater, about 12 cm or greater, about 14 cm or greater, about 16 cm or greater, about 18 cm or greater, about 20 cm or greater, or in ranges of about 1 cm to about 3 cm, about 2 cm to about 4 cm, about 3 cm to about 5 cm, about 4 cm to about 6 cm, about 5 cm to about 7 cm, about 6 cm to about 8 cm, about 7 cm to about 9 cm, about 8 cm to about 10 cm, about 9 cm to about 12 cm, about 10 cm to about 14 cm, about 12 cm to about 16 cm, about 14 cm to about 18 cm, or about 16 cm to about 20 cm. Generally, the first length is selected by balancing the need to space the gripping section 118 from the first and second prongs 110, 112 while minimizing the weight of the utensil 100 since the weight of the utensil 100 depends, in part, on the first length. In an example, the first length may be relatively small (e.g., about 7 cm or less) when the second length of the second section 116 is relatively long (e.g., about 15 cm or greater). In such an example, the relatively small first length minimizes the weight of the utensil 100 while the relatively long second length spaces the gripping section 118 from the first and second prongs 110, 112. In an example, the first length may be selected based on whether the first section 114 is formed from a relatively light material (e.g., aluminum) or a relatively heavy material (e.g., steel). In an example, the first length may be selected based on the type of beam that forms the first section 114.

The first section 114 may extend at a first angle θ relative to the first and second prongs 110, 112. The first angle θ may be the smallest angle measured between the longitudinal axis of the first section 114 and an axis that is parallel to and centrally located between the longitudinal axis of the longitudinal section 132 of the first and second prongs 110, 112. In an embodiment, the first angle θ may be selected to be about 90° to about 110°, about 100° to 120°, about 110° to about 130°, about 120° to about 140°, about 130° to about 150°, about 140° to about 160°, about 150° to about 170°, or about 160° to about 180º. The first angle θ may be selected to ensure that the gripping section 118 is sufficiently offset relative to the first and second prongs 110, 112 such that the user gripping the gripping section 118 is unlikely to be burned or uncomfortably heated by the heat source. In a particular example, the first angle θ is selected to be about 90° to about 135° to vertically space the gripping section 118 from the first and second prongs 110, 112 while minimizing any leverage generated by lifting an object with the first and second prongs 110, 112. It is noted that in the illustrated embodiment (e.g., when the first and second prongs 110, 112 are threadedly attached to the connector 104), the first angle θ may be selectively changed.

The second section 116 exhibits a second length measured parallel to a longitudinal (e.g., central) axis of the second section 116. The second length may be selected to be about 2.5 cm or greater, about 5 cm or greater, about 7.5 cm or greater, about 10 cm or greater, about 12.5 cm or greater, about 15 cm or greater, about 17.5 cm or greater, about 20 cm or greater, about 22.5 cm or greater, about 25 cm or greater, about 30 cm or greater, or in ranges of about 2.5 cm to about 7.5 cm, about 5 cm to about 10 cm, about 7.5 cm to about 12.5 cm, about 10 cm to about 15 cm, about 12.5 cm to about 17.5 cm, about 15 cm to about 20 cm, about 17.5 cm to about 22.5 cm, about 20 cm to about 25 cm, or about 22.5 cm to about 30 cm. Similar to the first length, the second length is selected by balancing the need to space the gripping section 118 from the first and second prongs 110, 112 while minimizing the weight of the lighting utensil. As such, the second length may be selected for any of the same reasons as the first length. In an example, the second length is selected to be greater than the first length since the second section 116 may primarily laterally offset the gripping section 118 from the first and second prongs 110, 112 thereby preventing or at least minimizing the likelihood that the gripping section 118 is disposed above heat source.

The second section 116 may extend at a second angle α relative to the first section 114. The second angle α may be the smallest angle measured between the longitudinal axis of the first section 114 and the longitudinal axis of the second section 116. In an embodiment, the second angle α may be selected to be about 75° to about 105°, about 90° to about 120°, about 105° to 135°, about 120° to about 150°, about 135° to about 165°, about 150° to about 180°, or about 165° to about 195°. The second angle α may be selected to ensure that the gripping section 118 is sufficiently offset relative to the first and second prongs 110, 112 such that the user gripping the gripping section 118 is unlikely to be burned or uncomfortably heated by the heat source. The second angle α may also be selected to improve the ergonomics of the handle 102. For example, the second angle α may be selected such that the wrist of the user remains relatively straight while using the utensil 100 since bending the wrist while holding a weight may cause pain or numbness when the user has carpal tunnel syndrome.

The gripping section 118 may exhibit a third length measured parallel to a longitudinal (e.g., central) axis thereof. The third length of the gripping section 118 may be selected to be about 7.5 cm or greater, about 10 cm or greater, about 12.5 cm or greater, about 15 cm or greater, about 17.5 cm or greater, about 20 cm or greater, about 22.5 cm or greater, about 25 cm or greater, or in ranges of about 10 cm to about 15 cm, about 12.5 cm to about 17.5 cm, about 15 cm to about 20 cm, about 17.5 cm to about 22.5 cm, or about 20 cm to about 25 cm. The third length is generally selected to be large enough to be easily gripped by an user. For example, the third length may be selected to be greater than about 12.5 cm thereby allowing most users to fit their first around the gripping section 118.

The gripping section 118 may extend at a fourth angle ϕ relative to the second section 116. The fourth angle ϕ may be selected to be about 60° to about 80°, about 70° to about 90°, about 80° to about 100°, about 90° to about 110°, or about 100° to 120°. The fourth angle ϕ may be selected to ensure that the gripping section 118 may be ergonomically gripped during use. The fourth angle ϕ may also be selected such that the gripping section 118 is not disposed above the heat source thereby preventing or at least inhibiting a user gripping the gripping section 118 to be burned or uncomfortably heated by the heat source.

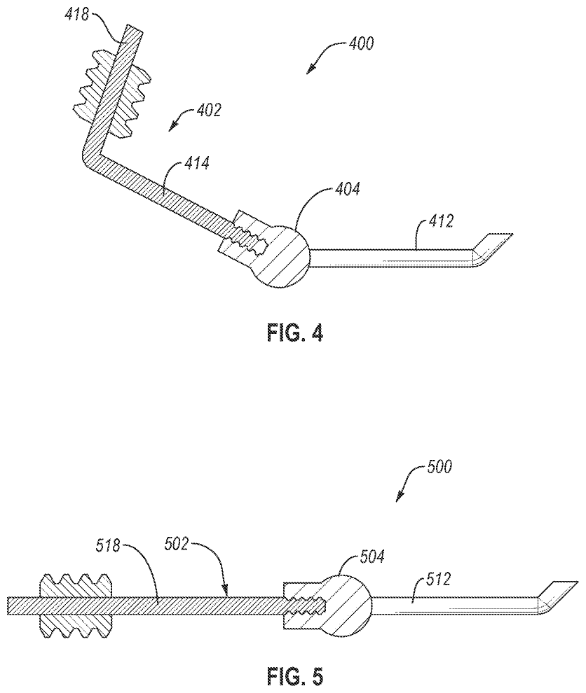

The handle 102 may exhibit other shapes other than what is illustrated in FIGS. 1A-1C. In an example, the first section 114 may be configured to laterally offset the gripping section 118 (e.g., the first angle θ is about 180°) and second section 116 may be configured to vertically spaced the gripping section 118 from the first and second prongs 110, 112. In other words, in such an example, the roles of the first section 114 and the second section 116 are reversed from what is illustrated in FIGS. 1A-1C. In an example, the handle 102 may include a third portion that extends between the first and second sections 114, 116. Other examples of shapes that the handle 102 may exhibit are illustrated in FIGS. 4 and 5, which will be discussed in more detail below.

In an embodiment, the handle 102 includes a handgrip 120. The handgrip 120 may be positioned on the gripping section 118. In an example, the handgrip 120 may be formed from a material that is more thermally insulating (i.e., exhibits a thermal conductivity that is less) than the rest of the handle 102. In such an example, the handgrip 120 may be formed from silicone, another polymer, a ceramic, or any other suitable material. Forming the handgrip 120 from a more insulating material may inhibit the user from becoming burned. For instance, as previously discussed, the utensil 100 is configured to be disposed over a heat source. The handle 102, with the exception of the handgrip 120, may be formed from a relatively high thermal conductive material, such as a metal. The relatively high thermal conductive material of the handle 102 may cause the gripping section 118 to be uncomfortably hot or cause the gripping section 118 to be burn the user if the user directly contacts the gripping section 118 and if at least the first and second prongs 110, 112 are disposed in the heat source for a prolonged period of time. However, the handgrip 120 may thermally isolate the user from the hot gripping section 118 thereby preventing the user from directly contacting the hot gripping section 118. In an example, the handgrip 120 may be softer than the gripping section 118 thereby making the utensil 100 more comfortable to use than if the handle 102 did not include the gripping section 118, especially when the utensil 100 is used for a prolong period of time (e.g., at a restaurant or during a cooking competition). In an example, the handgrip 120 may include one or more protrusions and/or recesses. The protrusions may be configured to fit between fingers of the user and the recesses may be configured to partially receive the fingers of the user. The protrusions and recesses may make the utensil 100 more comfortable to use. The protrusions and recesses may also decrease the likelihood that the individual drops the utensil 100 since dropping the utensil 100 may cause a hot object and/or utensil 100 to fall on the user's feet, damage the object, or ruin any food present on the object.

In an embodiment, the utensil 100 may include a hook 122 extending from the gripping section 118. Generally, the hook 122 extends from a portion of the gripping section 118 that is opposite the second section 116. The hook 122 is configured to allow the utensil 100 to be attached to and dangle from, for example, a grill. The hook 122 may be integrally formed (e.g., exhibit unitary construction) with the gripping section 118 or may be distinct from and attached to the gripping section 118. In an example, the hook 122 may be generally linear and extends from a non-parallel angle (e.g., about 80° to 100° angle) relative to the gripping section 118. In such an example, the hook 122 may prevent a user's hand slipping off the gripping section 118 during use in addition to allowing the hook 122 to attach the utensil 100 to a grill. In an example, the hook 122 may include a curved structure. In an embodiment, the utensil 100 includes a hook 122 extending from a portion of the handle 102 other than the gripping section 118. In an embodiment, the utensil 100 includes a cap (e.g., plastic cap) covering at least a terminal end of the hook 122 since the terminal end of hook 122 may be include rough edges or be rough.

As previously discussed, the utensil 100 includes a connector 104. In an embodiment, the connector 104 includes a first end 106, a second end 108, and a handle end 123. As previously discussed, the first and second ends 106, 108 are configured to allow the first and second prongs 110, 112, respectively, to be attached to the connector 104. The handle end 123 is configured to allow the handle 102 to be attached to and extend from the connector 104. As such, the connector 104 allows the handle 102 to be connected to the first and second prongs 110, 112. The connector 104 is also configured to allow the first and second prongs 110, 112 to move to vary a maximum distance therebetween, as will be discussed in more detail below. The connector 104 may be formed from any of the materials disclosed herein, such as aluminum or steel. In an embodiment, the connector 104 may exhibit a structure other than the illustrated structure. For example, the connector 104 may be a weld that attaches the handle 104 to the first and second prongs 110, 112.

In an embodiment, the connector 104 is integrally formed with the handle 102. In an embodiment, the connector 104 is distinct from and attached to the handle 102. In such an embodiment, the connector 104 may be attached to different handles depending on the current use of the utensil and the preference of the user using the utensil 100. In an example, the connector 104 may be attached to a thicker or otherwise stronger handle 102 when the utensil 100 is lifting a heavy object and may be attached to a lighter handle 102 when the utensil 100 is lifting a light object. In an example, the connector 104 may be attached to a first handle 102 that the user finds more ergonomical or comfortable, depending on the user's preference.

When the connector 104 is distinct from the handle 102, the handle 102 may be attached to the connector 104 using any suitable technique. In an example, the handle 102 may be configured to be threadedly attached to the connector 104. In such an example, the handle end 123 of the connector 104 may define a handle passageway 124 that is configured to receive a portion of the handle 102 (e.g., receive at least a portion of the first section 114). The handle passageway 124 and the portion of the handle 102 configured to be disposed in the handle passageway 124 may define one or more corresponding threads thereby allowing the handle 102 to be threadedly attached to the connector 104. It is noted that the handle 102 may be connected to the connector 104 using techniques other than a threaded attachment. For example, the handle 102 may be attached to the connector 104 using a pin, weld, or interference fit.

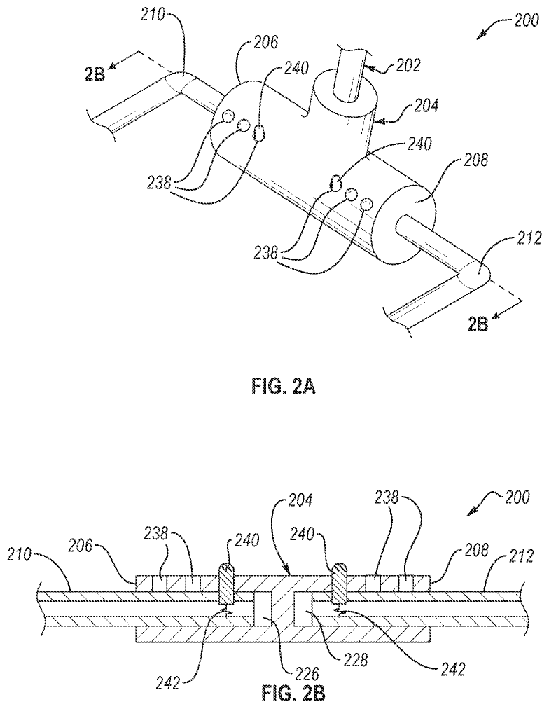

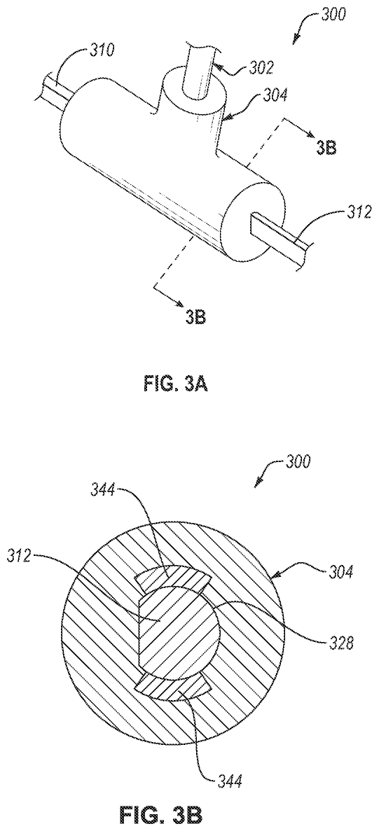

The connector 104 is distinct from the first and second prongs 110, 112 thereby allowing the first and second prongs 110, 112 to move relative to the connector 104. The connector 104 may be configured to have the first and second prongs 110, 112 connected thereto using any suitable technique. In an embodiment, as illustrated, the connector 104 is configured to be attached to the first and second prongs 110, 112 using a threaded attachment. To facilitate the threaded attachment, the first end 106 of the connector 104 defines a first passageway 126 and the second end 108 of the connector 104 defines a second passageway 128. The first passageway 126 is configured to receive a portion of the first prong 110 and the second passageway 128 is configured to receive a portion of the second prong 112. The first passageway 126 and the portion of the first prong 110 configured to be disposed in the first passageway 126 may define corresponding threads. The second passageway 128 and the portion of the second prong 112 configured to be disposed in the second passageway 128 may define corresponding threads. It is noted that the first and second prongs 110, 112 may be attached to the connector 104 using techniques other than a threaded attachment, examples of which are illustrated in FIGS. 2A-3B.

In an embodiment, the threads of the first prong 110 and the threads of the second prong 112 are different from each other. In such an embodiment, the threads of the first passageway 126 and the threads of the second passageway 128 are different since the threads of the first prong 110 correspond to the threads of the first passageway 126 and the threads of the second prong 112 correspond to the threads of the second passageway 128. The threads of the first and second prongs 110, 112 are different when the threads of the first and second prongs 110, 112 exhibit different at least one of thread angles, helix angles, pitches, minor diameter, pitch diameter, or major diameter. The different threads of the first and second prongs 110, 112 may prevent the first and second prongs 110, 112 from being inadvertently attached to the wrong passageway since attaching the first and second prongs 110, 112 to the wrong passageway may interfere with the ergonomics of the handle 102 and prevent the catch 134 from holding an object on the first and second prongs 110, 112. In an embodiment, the threads of the first and second prongs 110, 112 are the same.

The first end 106 and the second end 108 of the connector 104 exhibits a thickness that is greater than the thickness of the first and second prongs 110, 112 respectively. The increased thickness of the connector 104 allows the connector 104 to define the first passageway 126 and the second passageway 128. The increased thickness of the connector 104 also strengthens the connector 104 since the largest bending stresses applied to the connector 104 may be concentrated at or near the connector 104. The handle end 123 of the connector 104 may also exhibit a thickness that is greater than the thickness of the handle 102. The increased thickness of the handle end 123 relative to the handle 102 allows the handle end 123 to define the handle passageway 124. However, it is noted that the handle end 123 of the connector 104 may still exhibit a thickness that is greater than the handle 102 even when the handle 102 and the connector 104 are integrally formed. In an example, the handle end 123 of the connector 104 may exhibit a thickness that is the same as or substantially similar to the thickness of the handle 102 when the handle 102 and the connector 104 are integrally formed.

Each of the first and second prongs 110, 112 includes a lateral section 130 and a longitudinal section 132. The lateral section 130 is configured to be connected to the connector 104 and to increase the distance between the longitudinal sections 132. The longitudinal section 132 is configured to engage with the object. For example, the longitudinal section 132 may be configured to have at least a portion of the object resting thereof. The longitudinal section 132 may also be configured to be at least partially disposed between or through the object, such as between the rods of a grate or through the holes of a basket.

As previously discussed, the first and second prongs 110, 112 may be disposed in or near the heat source and may contact the object which exhibits an elevated temperature. As such, the first and second prongs 110, 112 may be formed from a material exhibiting a relatively high operating temperature (e.g., an operating temperature of about 100° C. or greater, about 300° C. or greater, about 500° C. or greater, or about 750° C. or greater). For example, the first and second prongs 110, 112 may be formed from steel (e.g., carbon steel, stainless steel, work hardened steel, etc.), aluminum, copper, titanium, another metal, one or more ceramics, or combinations thereof. In an embodiment, the first and second prongs 110, 112 may be formed from a solid material, a hollow material, an I-beam, an n-shaped beam, a v-shaped beam, or any other suitable structure. In an embodiment, the first and second prongs 110, 112 may exhibit a unitary structure or may be formed from two or more pieces.

As previously discussed, the lateral section 130 is configured to be connected to the connector 104. As such, in the illustrated embodiment, at least a portion of the lateral section 130 (e.g., 10-40%, 25-65%, 40-70%, or 65-100 of the lateral section 130) include one or more threads formed therein or thereon that are configured to engage with the threads of the connector 104.

The lateral section 130 exhibits a fourth length measured parallel to a longitudinal axis of the lateral section 130. The fourth length may be selected to be about 2 cm or greater, about 3 cm or greater, about 4 cm or greater, about 5 cm or greater, about 6 cm or greater, about 7 cm or greater, about 8 cm or greater, about 9 cm or greater, about 10 cm or greater, about 12 cm or greater, about 14 cm or greater, about 16 cm or greater, about 18 cm or greater, about 20 cm or greater, or in ranges of about 2 cm to about 4 cm, about 3 cm to about 5 cm, about 4 cm to about 6 cm, about 5 cm to about 7 cm, about 6 cm to about 8 cm, about 7 cm to about 9 cm, about 8 cm to about 10 cm, about 9 cm to about 12 cm, about 10 cm to about 14 cm, about 12 cm to about 16 cm, about 14 cm to about 18 cm, or about 16 cm to about 20 cm. The length may be selected based on at least one of the expected size of the object to be lifted by the utensil 100 (e.g., the expected width of the object or the expected spacing between the rods of the grate or the holes of the basket), or the desired weight of the utensil 100.

In an embodiment, the connector 104 and the lateral section 130 are configured such that the lateral section 130 extends at a perpendicular angle relative to the first section 114 when the lateral section 130 is attached to the connector 104. The lateral section 130 extending perpendicularly relative to the first section 114 allows the first and second prongs 110, 112 to switch from the first configuration to the second configuration without changing distance that the first and second prongs 110, 112 extend from the connector 104, wherein the distance is measured in a direction that is parallel to the longitudinal axis of the longitudinal section 132. In an embodiment, the connector 104 and the lateral section 130 are configured such that the smallest angle measured between the first section 114 and the lateral section 130 is an acute angle when the lateral section 130 is attached to the connector 104. In such an embodiment, switching the first and second prongs 110, 112 from the first configuration to the second configuration decreases the distance that the first and second prongs 110, 112 extend from the connector 104, wherein the distance is measured in a direction that is parallel to the longitudinal axis of the longitudinal section 132. In an embodiment, the connector 104 and the lateral section 130 are configured such that the smallest angle measured between the first section 114 and the lateral section 130 is an obtuse angle when the lateral section 130 is attached to the connector 104. In such an embodiment, switching the first and second prongs 110, 112 from the first configuration to the second configuration increases the distance that the first and second prongs 110, 112 extend from the connector 104, wherein the distance is measured in a direction that is parallel to the longitudinal axis of the longitudinal section 132.

The longitudinal section 132 extends from the lateral section 130. The longitudinal section 132 may exhibit a fifth length. The fifth length may be about 1 cm or greater, about 2 cm or greater, about 3 cm or greater, about 4 cm or greater, about 5 cm or greater, about 7.5 cm or greater, about 10 cm or greater, about 12.5 cm or greater, about 15 cm or greater, about 17.5 cm or greater, about 20 cm or greater, about 22.5 cm or greater, about 25 cm or greater, about 30 cm or greater, or in ranges of about 1 cm to about 3 cm, about 2 cm to about 4 cm, about 3 cm to about 5 cm, about 4 cm to about 7.5 cm, about 5 cm to about 10 cm, about 7.5 cm to about 12.5 cm, about 10 cm to about 15 cm, about 12.5 cm to about 17.5 cm, about 15 cm to about 20 cm, about 17.5 cm to about 22.5 cm, about 20 cm to about 25 cm, or about 22.5 cm to about 30 cm. The fifth length may be selected based on the size of the object to be lifted. For example, the fifth length may be relatively long (e.g., about 12.5 cm or greater) when the object is relatively large or relatively short (e.g., about 12.5 cm or less) when the object is relatively short. It is noted that, generally, it is desirable to minimize the fifth length to decrease the overall weight of the utensil 100 but, depending on the size of the object, the minimum length of the longitudinal section 132 is limited.

The longitudinal section 132 may extend at an angle κ relative to the lateral section 130. In an embodiment, the angle κ is general selected such that the longitudinal sections 132 of the first and second prongs 110, 112 are parallel to each other which may facilitate inserting the first and second prongs 110, 112, for instance, between the rods of the grate or into the holes of the basket. For example, the angle κ may be selected to be about 90°, less than 90°, or greater than 90° when the smallest angle between the first section 114 and the lateral section 130 is a perpendicular, acute, or obtuse, respectively. In an embodiment, the angle κ is selected such that the distance between the longitudinal sections 132 of the first and second prongs 110, 112 increase with increasing distance from the connector 104. In such an embodiment, the angle κ increases the base formed by the longitudinal section 132 on which the object may rest. In an embodiment, the angle κ is selected such that the distance between the longitudinal sections 132 of the first and second prongs 110, 112 decrease with increasing distance from the connector 104.

In some embodiments, the first and second prongs 110, 112 may include a catch 134 extending from a portion of the longitudinal sections 132 thereof. The catch 134 extends at an angle β relative to the longitudinal axis of the longitudinal sections 132. The angle β is the smallest angle between the catch 134 and the longitudinal section 132 and is selected to be non-parallel to the longitudinal section 132 (i.e., the angle β is not 180°). The angle β may be selected to be about 75° to about 105°, about 90° to about 120°, about 105° to about 135°, about 120° to about 150°, about 135° to about 165°, or about 150° to about 175°. Extending the catch 134 at a non-parallel angle relative to the longitudinal section 132 allows the catch 134 to at least inhibit an object from sliding off the longitudinal section 132. For example, when the utensil 100 does not include the catch 134, the utensil 100 must be held generally parallel to a horizon (e.g., a plane perpendicular to a gravitational force) because holding the utensil 100 such that the longitudinal section 132 exhibits an angle relative to the horizon may allow the object to overcome static friction and slide off the longitudinal section. However, when the utensil 100 includes the catch 134, the catch 134 forms a barrier to the object sliding off the longitudinal sections 132 even when the longitudinal sections 132 exhibit an angle that would otherwise cause the object to slide off the longitudinal sections 132. As such, the catch 134 allows the utensil 100 to be held at a greater range of angles without the object sliding off the longitudinal sections 130. It is noted that the ability of the catch 134 to act as a barrier to the object sliding off the longitudinal sections 130 increases as the angle β decreases. However, maneuvering the object over the longitudinal section 130 (e.g., positioned the longitudinal section 130 between the rods of the grate or through the holes of the basket) may become more difficult as the angle β is decreased. As such, the angle β may be selected based on balancing these factors.

The catch 134 may exhibit a length of about 0.5 or greater, about 1 cm of greater, about 1.5 cm or greater, about 2 cm or greater, about 2.5 cm or greater, about 3 cm or greater, about 4 cm or greater, about 5 cm or greater, about 6 cm or greater, about 7 cm or greater, about 8 cm or greater, about 9 cm or greater, about 10 cm or greater, or in ranges of about 0.5 cm to about 1.5 cm, about 1 cm to about 2 cm, about 1.5 cm to about 2.5 cm, about 2 cm to about 3 cm, about 2.5 cm to about 4 cm, about 3 cm to about 5 cm, about 4 cm to about 6 cm, about 5 cm to about 7 cm, about 6 cm to about 8 cm, about 7 cm to about 9 cm, or about 8 cm to about 10 cm. In an embodiment, the length of the catch 134 may be selected to be equal to or less than a length of the longitudinal section 132.

The utensil 100 is configured to switch between a first configuration and a second configuration. FIGS. 1D and 1E are enlarged isometric views of a portion of the utensil 100 illustrating the utensil 100 in the first and second configurations, respectively, according to an embodiment. The utensil 100 exhibits a first maximum distance D₁ measured between the longitudinal portions 132 of the first and second prongs 110, 112 when the utensil 100 is in the first configuration. The utensil 100 exhibits a second maximum distance D₂ measured between the longitudinal portions 132 of the first and second prongs 110, 112 when the utensil 100 is in the second configuration. The second maximum distance D₁ is different (e.g., larger) than the first maximum distance D₂.

The ability of the utensil 100 to switch between the first and second configurations facilitates manipulating different objects. In an example, the utensil 100 may be used to lift a grate and a basket. The grate includes a plurality of parallel rods having gaps therebetween and, optionally, a plurality of perpendicular rods that intersect the plurality of parallel rods. The basket defines a plurality of openings. The spacing of the gaps of the grate and the spacing of the holes may be different. For instance, the spacing of the gaps of the grate may be measured in inches (e.g., about ½ inch, about ⅝ inch, about ¾ inch, about ⅞ inch, about 1 inch, about 1⅛ inch, about 1¼ inch, about 1½ inch, etc.) and the spacing of the holes may be measured in centimeters (e.g., about 0.5 cm, about 1 cm, about 1.5 cm, about 2 cm, about 2.5 cm, about 3 cm, about 3.5 cm, or about 4 cm), or vice versa. When the spacing of the gaps and holes are different, two different conventional utensils may be needed to manipulate the grate and the basket. In particular, a first conventional utensil having a first spacing between the prongs thereof may be needed to position the prongs through the gaps of the grate. Positioning the prongs through the gaps may allow the prongs to be positioned below an object positioned on the grates (e.g., a pot or pan) or to position under the perpendicular rods. Due to the different spacing between the gaps and the holes, the spacing between the prongs of the first conventional utensil may be unable to fit into the holes basket and, as such, a second conventional utensil having a second spacing between the prongs thereof may be needed to manipulate the basket (e.g., be positioned through the holes of the basket). However, the utensil 100 may be able to manipulate both the grate and the basket. For instance, the distance between the first and second prongs 110, 112 may correspond to the spacing of the gaps of the grate when the utensil 100 is in the first configuration. Meanwhile, the distance between the first and second prongs 110, 112 may correspond to the spacing of the holes of the basket when the utensil 100 is in the second configuration. As such, the utensil 100 may be used to manipulate both the grate and the basket whereas two different conventional utensils are requires to manipulate both the grate and the basket. In another example, the utensil 100 may be used to lift differently sized objects. For instance, when the first maximum distance D₁ is less than the second maximum distance D₂, the utensil 100 may exhibit the first configuration when lifting a relatively small object and the second configuration when lifting a relatively large object. In such an instance, the first and second configurations of the utensil 100 may better distribute the weight of the object (e.g., positioned close to the edges of the object) such that the object is less likely to tip over. Also, manipulating the relatively small object with the utensil 100 in the first configuration may prevent the relatively small object from slipping between the first and second prongs 110, 112 unlike the utensil 100 exhibiting the second configuration. Again, two different conventional utensils may be needed to manipulate the relative small object and the relatively large object as effectively as the utensil 100.

The first and second maximum distances D₁ and D₂ may be independently selected to be about 5 mm to about 10 mm, about 7.5 mm to about 1.25 cm, about 1 cm to about 1.5 cm, about 1.25 cm to about 2 cm, about 1.5 cm to about 2.5 cm, about 2 cm to about 3 cm, about 2.5 cm to about 3.5 cm, about 3 cm to about 4 cm, about 3.5 cm to about 4.5 cm, about 4 cm to about 5 cm, about 4.5 cm to about 6 cm, about 5 cm to about 7 cm, about 6 cm to about 8 cm, about 7 cm to about 9 cm, about 8 cm to about 10 cm, about 9 cm to about 12 cm, about 10 cm to about 15 cm, about 12.5 cm to about 17.5 cm, about 15 cm to about 20 cm, about 17.5 cm to about 22.5 cm, about 20 cm to about 25 cm, about 22.5 cm to about 27.5 cm, about 25 cm to about 30 cm, about 27.5 cm to about 32.5 cm, about 30 cm to about 35 cm, about 32.5 cm to about 37.5 cm, about 35 cm to about 40 cm, about 37.5 cm to about 42.5 cm, or about 40 cm or greater.

In an embodiment, the first maximum distance D₁ and/or the second maximum distance D₂ may be selected to be in the metric system. The first maximum distance D₁ and/or the second maximum distance D₂ are in the metric system when the first maximum distance D₁ and/or the second maximum distance D₂ are at least one of n, ½*n, ⅓*n, or ¼*n where n is an integer measured in mm or cm. Selecting the first maximum distance D₁ and/or the second maximum distance D₂ to be in the metric system may facilitate manipulating an object that is designed using the metric system since the spacing (e.g., spacing between gaps or holes) of such an object is likely to be in the metric system. In an embodiment, the first maximum distance D₁ and/or the second maximum distance D₂ may be selected to be in the imperial system. The first maximum distance D₁ and/or the second maximum distance D₂ are in the imperial system when the first maximum distance D₁ and/or the second maximum distance D₂ are at least one of n, ½*n, ⅓*n, ¼*n, ⅛*n, or 1/16*n where n is an integer measured in inches. Selecting the first maximum distance D₁ and/or the second maximum distance D₂ to be in the imperial system may facilitate manipulating an object that is designed using the imperial system since the spacing (e.g., spacing between gaps or holes) of such an object is likely to be in the imperial system.

The utensil 100 may switch between the first and second configurations using any suitable system or method. In other words, the maximum distance between the first and second prongs 110, 112 may be changed using any suitable system or method. In an embodiment, as illustrated, the first and second prongs 110, 112 are threadedly attached to the connector 104 and this threaded attachment between the first and second prongs 110, 112 and the connector 104 are configured to switch the utensil 100 between the first and second configurations. In particular, rotating at least one of the first prong 110 or the second prong 112 relative to the connector 104 may cause the distance between the first and second prongs 110, 112 to change.

The threads of the first and second prongs 110, 112 may be standard threads (i.e., right-handed threads) or counter threads (i.e., left-handed threads). The direction that the first and second prongs 110, 112 need to be rotated to increase or decrease the maximum distance therebetween depends on whether the first and second prongs 110, 112 are standard or counter threads. In an embodiment, the threads of both the first and second prongs 110, 112 are counter threads or, more particularly, standard threads since standard threads are more commonly used. In an embodiment, the threads of one of the first prong 110 or the second prong 112 is standard threaded and the other of the first prong 110 or the second prong 112 is counter threaded. To illustrate the benefit of this arrangement, the utensil 100 is oriented such that the longitudinal portions 132 are horizontal (e.g., perpendicular to gravity) and the longitudinal portions 132 are closer to the individual than the handle 104. In such an embodiment, the rotating both of the first and second prongs 110, 112 in the same direction (e.g., either upwards or downwards) causes the distance between the first and second prongs 110, 112 to increase or decrease.

The utensil 100 may include nuts 136 attached to the first and second prongs 110, 112. The nuts 136 may be configured to prevent or allow rotation of the first and second prongs 110, 112 relative to the connector 104. For example, the nuts 136 may be rotated to press against the connector 104 when rotation of the first and second prongs 110, 112 is to be restricted and to be rotated away from the connector 104 when rotation of the first and second prongs 110, 112 are to be permitted. The nuts 136 exhibits threads that correspond to the threads of the prongs to which the nuts 136 are attached.

For descriptive purposes, the utensil 100 is oriented such that the longitudinal portions 132 are horizontal (e.g., perpendicular to gravity) and the longitudinal portions 132 are closer to the individual than the handle 104. In such an orientation, in a particular embodiment, the first (left) prong 110 exhibits standard threads and the second (right) prong 112 exhibits counter threads. In such an embodiment, lifting an object with the first and second prongs 110, 112 applies a downward force to the first and second prongs 110, 112. The downward force applied to the first and second prongs 110, 112 may cause the first and second prongs 110, 112 to move downward if the downward force is sufficiently large. Due to the threads of the first and second prongs 110, 112, the downward movement of the first and second prongs 110, 112 tightens the nuts 136 against the connector 104 thereby inhibiting further movement of the first and second prongs 110, 112. In other words, the threads and the presence of the nut 136 in this particular embodiment causes the utensil 100 to be self-tightening.

It is noted that the utensil 100 may exhibit one or more configurations in addition to the first configuration and the second configuration. For example, the utensil 100 may exhibit one or more additional configurations each exhibiting a maximum distance between the first and second prongs 110, 112 that is different than (e.g., less than, greater than, or between) the first maximum distance D₁ and the second maximum distance D₂.

In an embodiment, not shown, the utensil 100 is configured such that the distance between the first and second prongs 110, 112 is fixed (i.e., unchanging). In such an embodiment, the first and second prongs 110, 112 are non-moveably attached to the connector 104. In an example, the first and second prongs 110, 112 may be fixedly attached to the connector 104 (e.g., the first and second prongs 110, 112 are welded to the connector 104). In an example, the first and second prongs 110, 112 are integrally formed together (e.g., exhibit single piece construction) thereby preventing the first and second prongs 110, 112 from moving relative to each other.

It is noted that the utensils disclosed herein may switch between configurations using systems and methods other than the threaded attachment illustrated in FIGS. 1A-1E. Additional examples of systems and methods for switching the utensils disclosed herein between different configurations are illustrated in FIGS. 2A-3B. However, it is noted that systems and methods may be used to switch the utensils disclosed herein between configurations using systems and methods other than what is illustrated in FIGS. 1A-3B.

FIG. 2A is an isometric view of a portion of a utensil 200, according to an embodiment. FIG. 2B is a cross-sectional view of the utensil 200 taken along plane 2B-2B. Except as otherwise disclosed herein, the utensil 200 is the same as or substantially similar to any of the utensils disclosed herein. For example, the utensil 200 includes a handle 202, a connector 204, a first prong 210, and a second prong 212.

The utensil 200 uses a locking button system to controllably change the configuration of the utensil 200. The locking button system includes a plurality of holes 238 extending through the connector 204. The locking button system may include a plurality of holes 238 on the first end 206 of the connector 204 (e.g., extending from the first passageway 226 to an exterior of the connector 204) and a plurality of holes 238 on the second end 208 of the connector 204 (e.g., extending from the second passageway 226 to an exterior of the connector 204.

The locking button system further includes at least one push button locker 240 formed on each of the first and second prongs 210, 212. The push button locker 240 exhibits a size and shape that allows the push button locker 240 to extend through the holes 238. The push button locker 240 is configured to switch between a first, extended state and a second, retracted state. The push button locker 240 may extend from its respective prong when the push button locker 240 is in the first, extended state. The push button locker 240 may be in the first, extended state when no or substantially no external force is applied thereto. The push button locker 240 may be at least partially retracted into its respective prong when in the second, retracted state. The push button locker 240 may exhibit the second, retracted state when a force is applied to the push button locker 240 that moves the push button locker 240 into its respective prong. Each of the first and second prongs 210, 212 may include a spring 242 or other biasing element that is configured to cause the push button locker 240 to be in the first, extended state unless a force is applied to the push button locker 240.

In an embodiment, the push button locker 240 of the first prong 210 may only fit in the holes 238 on the first side 206 of the connector 204 and/or the push button locker 240 of the second prong 212 may only fit in the holes 238 on the second side 206 of the connector 204 to prevent the first and second prongs 210, 212 being positioned on the wrong side of the connector 204. In other words, the push button lockers 240 of the first and second prongs 210, 212 and the holes 238 on the first and second ends 206, 208 of the connector 204 may be different. In an embodiment, the push button lockers 240 of the first and second prongs 210, 212 and the holes 238 on the first and second ends 206, 208 of the connector 204 may be the same.

In an embodiment, the first and second prongs 210, 212 are not initially attached to the connector 204. In such an embodiment, the push button locker 240 may initially be in the first, extended state. A force may then be applied to the push button locker 240 such that the push button locker 240 is in the second, retracted state. While the push button locker 240 is in the second, retracted state, its prong may be inserted into its respective passageway. Once in the passageway, the connector 204 may maintain the push button locker 240 in the second, retracted state until the push button locker 240 is positioned adjacent to one of the holes 238. When the push button locker 240 is adjacent to one of the holes 238, the push button locker 240 may switch to the first, extended state and be positioned within the hole 238. Positioning the push button locker 240 in the hole 238 may lock the position of the prong relative to the connector 240. In an embodiment, when the push button locker 240 is in a first hole, the position of the prong in the connector 204 may be changed by applying a force to the push button locker 240 such that the push button locker 240 is in the second, retracted state and is no longer within the first hole. When the push button locker 240 is in the second, retracted position, the prong may be move in the connector 204 until the push button locker 240 is adjacent to a second hole that is different than the first hole. When the push button locker 240 is adjacent to the second hole, the push button locker 240 may switch from the second, retracted state to the first, extended state and extend through the second hole.

FIG. 3A is an isometric view of a portion of a utensil 300, according to an embodiment. FIG. 3B is a cross-sectional view of the utensil 300 taken along plane 3B-3B. Except as otherwise disclosed herein, the utensil 300 is the same as or substantially similar to any of the utensils disclosed herein. For example, the utensil 300 includes a handle 302, a connector 304, a first prong 310, and a second prong 312.

Unlike the prongs discussed above (which exhibited a circular cross-sectional shape), first and second prongs 310, 312 exhibit a non-circular cross-sectional shape. For example, as illustrated, the first and second prongs 310, 312 exhibit a truncated generally circular cross-sectional shape thought, it is noted that the first and second prongs 310, 312 may exhibit other non-circular cross-sectional shapes (e.g., oval, ellipsoidal, triangular, or square cross-sectional shapes). The first passageway (not shown, obscured) and the second passageway 328 exhibit a non-circular cross-sectional shape that corresponds to the non-circular cross-sectional shape of the first prong 310 and the second prong 312, respectively. The non-circular cross-sectional shape of the first and second prongs 310, 312 and the corresponding shapes of the passageways prevent the first and second prongs 310, 312 from rotating relative to the connector 304. As such, an object may be positioned on the first and second prongs 310, 312 without the first and second prongs 310, 312 rotating relative to the connector 304.

In an embodiment, the cross-sectional shape of the first prong 310 and the first passageway are different than the cross-sectional shape of the second prong 310 and the second passageway 328 to prevent the first and second prongs 310, 312 being positioned on the wrong side of the connector 304. In an embodiment, the cross-sectional shape of the first prong 310 and the first passageway are the same as the cross-sectional shape of the second prong 310 and the second passageway 328.

In an embodiment, the first and second prongs 310, 312 may rely on friction between the connector 304 and the first and second prongs 310, 312 to prevent the first and second prongs 310, 312 from moving into or out of the connector 304 while the utensil 300 is manipulating an object. In an embodiment, the utensil 300 may include a friction enhancing element 344 disposed in the connector 304. The friction enhancing element 344 exhibits a greater coefficient static friction with the first and second prongs 310, 312 than the connector 304 and the first and second prongs 310, 312. As such, the friction enhancing element 344 better prevents or at least inhibits movement of the first and second prongs 310, 312 into or out of the connector 304 during use than if the utensil 300 did not include the friction enhancing feature 344. Examples of the friction enhancing element 344 includes a silicone.

When the utensil 300 includes the friction enhancing element 344, the friction enhancing element 344 may define at least partially of the passageway that receives the first and second prongs 310, 312. In an embodiment, when the friction enhancing element 344 includes a compressible material (e.g., silicone), the passageway may exhibit a cross-sectional shape that differs slightly from or is slightly smaller than the prong that the passageway receives. In such an embodiment, inserting the prong into the passageway may compress the friction enhancing element 344 which, in turn, increases the force applied from the friction enhancing feature 344 to the prong. The increased force may prevent or at least inhibit movement of the first and second prongs 310, 312 into or out of the connector 304 during use than if the friction enhancing element 344 is not compressed.

As previously discussed, the utensils disclosed herein may exhibit shapes other than the shapes of the utensils discussed above and most clearly illustrated in FIGS. 1A and 1B. FIGS. 4 and 5 are cross-sectional view of utensils exhibiting different shapes, according to different embodiments. Except as otherwise disclosed herein, the utensils shown in FIGS. 4 and 5 are the same as or substantially similar to any of the utensils disclosed herein.

Referring to FIG. 4, the utensil 400 includes a handle 402, a connector 404, a first prong (not shown), and a second prong 412. Unlike the handle 102, the handle 402 only includes a single section 414 extending from the connector 402 to the gripping section 418. The shape of the handle 402 may cause the handle 402 to be less ergonomical than the handle 102. However, the handle 402 may cause the gripping section 418 to be further laterally spaced from a heat source than the handle 102 if the overall length of the handle 402 is the same as the handle 102 (excluding the hook 122).

Referring to FIG. 5, the utensil 500 includes a handle 502, a connector 504, a first prong (not shown), and a second prong 512. Unlike the handle 102 and the handled 402, the handle 502 may be substantially linear and only includes a gripping section 518 extending from the connector 504. The shape of the handle 502 may cause the handle 502 to be less ergonomical than the handle 102 and the handle 502. However, the handle 502 may cause the gripping section 518 to be further laterally spaced from a heat source than the handle 102 and the handle 402 if the overall length of the handles are the same (excluding the hook 122). The flat profile of the utensil 500 may also facilitate storage of the utensil 500 compared to the handle 102 and the handle 402.

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially.” “generally,” etc.) indicate structurally or functionally insignificant variations. In an example, when the term of degree is included with a term indicating quantity, the term of degree is interpreted to mean ±10%, ±5%, or ±2% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

What is claimed is:

1. A utensil, comprising:
a handle;
a connector;
a first prong attached to the handle via the connector; and
a second prong attached to the handle via the connector;
wherein the first prong and the second prong exhibit a first configuration and a second configuration, the first prong and the second prong exhibiting a first maximum distance therebetween when the first prong and the second prong are in the first configuration and a second maximum distance therebetween when the first prong and the second prong are in the second configuration, the first maximum distance different than the second maximum distance.

2. The utensil of claim 1, wherein the handle is substantially linear.

3. The utensil of claim 1, wherein the handle includes section and a gripping section extending from the section, the section positioned closer to the connector than the gripping section, the gripping section extending at a non-parallel angle relative to the section.

4. The utensil of claim 1, wherein the handle includes a first section extending from the connector, a second section extending from the first section, and a gripping section extending from the second section.

5. The utensil of claim 1, wherein the handle includes a hand grip disposed on a gripping section.

6. The utensil of claim 1, wherein the connector is integrally formed with the handle.

7. The utensil of claim 1, wherein the connector is distinct from the handle.

8. The utensil of claim 1, wherein the first prong and the second prong each include a lateral section extending from the connector and a longitudinal section extending from the lateral section.

9. The utensil of claim 8, wherein the first prong and the second prong each include a catch extending from the longitudinal section.

10. The utensil of claim 1, wherein the first prong and the second prong are each threadedly attached to the connector, and wherein the first prong and the second prong switch from the first configuration to the second configuration by rotating at least one of the first prong or the second prong relative to the connector.

11. The utensil of claim 10, further comprising two nuts threadedly attached to the first prong and the second prong.

12. The utensil of claim 10, wherein one of the first prong or the second prong is standard threaded and the other of the first prong or the second prong is counter threaded.

13. The utensil of claim 1, wherein the connector includes a first end and a second end, the first prong extending from the first end and the second prong extending from the second end.

14. The utensil of claim 1, wherein:
the connector includes a plurality of holes extending therethrough; and
each of the first prong and the second prong include a push button locker configured to switch between a first, extended state and a second, retracted state, the push button locker configured to be positioned through at least some of the plurality of holes.

15. The utensil of claim 1, wherein at least a portion of the first prong and the second prong exhibit a corresponding non-circular cross-sectional shape.

16. The utensil of claim 15, wherein the connector includes a friction enhancing element defining at least a portion of passageways configured to receive the first prong and the second prong.

17. The utensil of claim 1, further comprising a hook extending from the handle.

18. A method of using the utensil of claim 1, the method comprising:
switching the first prong and the second prong from the first configuration to the second configuration.

19. The method of claim 18, wherein switching the first prong and the second prong from the first configuration to the second configuration includes:
pressing a push button locker of at least one of the first prong or second prong to switch the push button locker from a first, extended state to a second, retracted state; and
when the push button locker is in the second, retracted state, moving at least one of the first prong or the second prong inwardly or outwardly until the push button locker is adjacent to a hole defined by and extending through the connector.

20. The method of claim 18, further comprising:
positioning the first prong and the second prong between rods of a grate or through holes of a basket, wherein the grate or the basket is disposed over a heat source.
